(19) United States
(12) Patent Application Publication
(10) Pub. No.: US 2022/0180290 A1
(43) Pub. Date: Jun. 9, 2022

(54) USING MACHINE LEARNING TO ASSIGN DEVELOPERS TO SOFTWARE DEFECTS

(71) Applicant: MICRO FOCUS LLC, SANTA CLARA, CA (US)

(72) Inventors: Enhui Xin, Shanghai (CN); Cunyang Gong, Shanghai (CN); Chunjiang Zhu, Shanghai (CN)

(73) Assignee: MICRO FOCUS LLC, SANTA CLARA, CA (US)

(21) Appl. No.: 17/437,341

(22) PCT Filed: Apr. 15, 2019
(86) PCT No.: PCT/CN2019/082708

§ 371 Date: Sep. 8, 2021

(51) Int. Cl. G06Q 10/06; G06F 11/36; G06F 40/40; G06N 3/04

(52) U.S. Cl. CPC G06Q 10/063112; G06N 3/04; G06F 40/40; G06F 11/362

(57) ABSTRACT

A technique includes processing, by a computer, data representing a software defect report to extract features from the software defect report. The software defect report contains information that identifies a defect in a software product. The technique includes applying, by the computer, a feedforward neural network classifier to the features to identify a developer to assign to the identified defect.

### BACKGROUND

A software product may have software bugs, or defects, which are detected by developers and users of the product. A software developer may be assigned to resolve a defect in a software product. Resolving the defect may include fixing the defect, determining that the defect is unfixable, determining that the defect is invalid, and so forth. The software defect may be detailed in a software defect report, which has various fields to describe the defect, such as a summary field, a detailed description field, a field containing comments regarding the ongoing resolution of the defect, and so forth.

### BRIEF DESCRIPTION OF THE DRAWINGS

FIG. 1 is a schematic diagram of a computer system to recommend developers to assign to software defects according to an example implementation.

FIG. 2 is an example of a software defect report illustrating features that may be extracted from the report according to an example implementation.

FIG. 3 is an illustration of a process to train and use a feedforward neural network classifier to recommend developers for software defects according to an example implementation.

FIG. 4 is a flow diagram depicting a technique to use a feedforward neural network classifier to identify a developer to assign to a software defect identified in a software defect report according to an example implementation.

FIG. 5 is an illustration of machine executable instructions that are stored on a machine readable storage medium that, when executed by a machine, cause the machine to recommend software developers to resolve defects associated with software defect reports according to an example implementation.

FIG. 6 is an illustration of an apparatus to apply a feedforward neural network classifier to assign a defect associated with a software defect report to a restorer according to an example implementation.

### DETAILED DESCRIPTION

Software defects in a particular software product may be discovered by developers of the product, as well as the product's users. The discovery of software defects results in the creation of corresponding software defect reports. In general, a software defect report is a tool that allows an associated defect to be documented; and the software defect report provides a mechanism to track the progress of the process to resolve the defect as well as document the steps taken in the resolution. Newly created software defect reports may be initially evaluated in a triage process in which the associated software defect reports are assessed to determine the validity of the reports, and for the validated reports, restorers, or developers, are assigned to resolve the defects that are identified in the reports. In this context, a “restorer,” or “developer,” refers to a person who is assigned to correct or otherwise resolve a particular defect that is identified in an associated software defect report. As examples, a developer may be a programmer, an engineer, manager, a group leader and so forth.

In the triage process, the newly created software defect reports may be reviewed and evaluated by a test group manager for purposes of performing initial assessments of the validities of the associated software defects. For software defects that are initially validated by the test group leaders, the corresponding software defect reports may be handed over to team leaders that assign the identified software defects by matching the defects to the most suitable developers according to experience. However, due to the ever-increasing scale of modern software products, there is a correspondingly ever-increasingly number of software defect reports that are being generated daily. Given this large volume of software defect reports, it may take several weeks or days on average from the initial discovery of a given software defect to the time when the defect is assigned to a developer.

In accordance with example implementations that are described herein, an extreme machine learning classifier, or feedforward neural network classifier, is trained and used to identify a software developer to assign to a given software defect report for purposes of resolving a software defect that is identified in the report. The automated assignment of developers to software defect reports allows a relatively fast and accurate defect triage, which minimizes time and costs.

In general, a feedforward neural network classifier may be trained relatively quickly, as the classifier may have a single hidden layer. Accordingly, there relatively minimal manual intervention involved in determining the weights for this type of machine learning classifier. Moreover, the feedforward neural network classifier provides for a relatively large generalization for data sets and has a relatively high accuracy.

As described herein, to train the feedforward neural network classifier, in accordance with example implementations, the software defect reports are pre-processed to extract features from certain fields of the reports, such as, the summary field (or title), the description field, and the comments field. As described herein, these extracted features are processed using such techniques as stemming and stop word deletion. Feature selection may then be applied to the processed extracted features to remove noise from the features to derive a feature set that is used to train the classifier.

More specifically, the feature set may be transformed into a vector space model (VSM). For purposes of constructing the VSM, associated weights may be determined for each feature of the feature set to reflect the importance of each feature to a particular software report, versus how often the word appears in the collection of software reports (i.e., the corpus). In accordance with example implementations, the VSM is a tuple that has dimensions represent whether certain features are present in a given software defect report. These features correspond to the dimensions of the tuple, so that if a software defect report has a feature that corresponds to a particular dimension of the tuple, the corresponding dimension value is nonzero, and if the software defect report does not contain the feature, the dimension value is zero. Moreover, as further described herein, the dimension values may be weighted to reflect the relative importances of the features.

For training, the feedforward neural network receives the VSM as input and receives labels (already determined classifications), which trains the classifier to classify unclassified software defect reports to assign these reports to developers.

After the feedforward neural network classifier is trained, the classifier may then be used to classify software defect reports with unassigned developers based on the corresponding VSMs for these reports. In this regard, the application of the classifier may, in accordance with some implementations, assign a given software defect report to a particular class, and this class, in turn, may correspond to a single developer, a group of developers, and so forth.

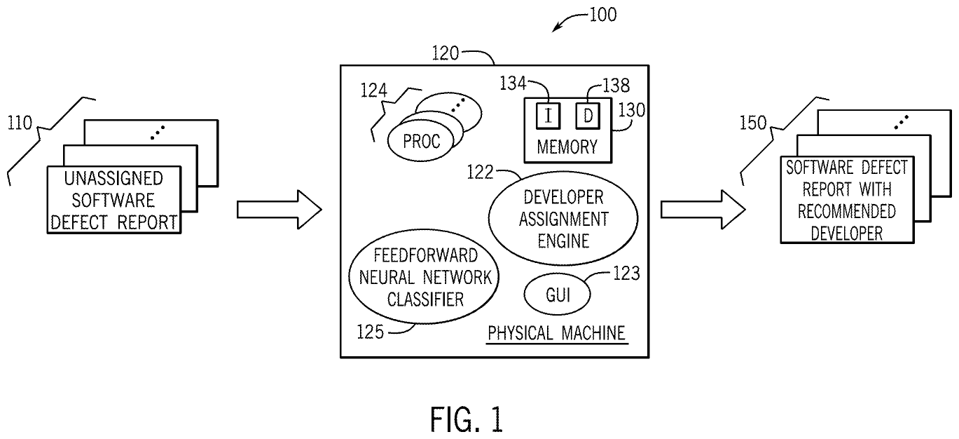

As a more specific example, FIG. 1 depicts a computer system 100 in accordance with some implementations. In general, the computer system 100 includes a physical machine 120, which is constructed to apply machine learning, and more specifically, apply a feedforward neural network classifier 125, to unassigned software defect reports 110 for purposes of generating corresponding software defect reports 150 that contain or have recommended developers to resolve defects that are identified in the software defect reports 110. In this context, an “unassigned software defect report” refers to a software defect report for which a developer has not been assigned or a software defect report in which a classifier-based developer is to be recommended.

The way in which the software developer assignments are presented may vary, depending on the particular implementation. For example, in accordance with some implementations the software report 150 may have an assigned developer field that is automatically filled in with the name of a developer based on the classification by the feedforward neural network classifier 125. In accordance with further example implementations, a graphical user interface (GUI) 123 may display (via a dialog box, for example) a list of one or multiple developers that are recommended based on the classification by the feedforward neural network classifier 125.

The physical machine 120, in accordance with example implementations, is an actual physical machine that is made up of actual hardware and actual machine executable instructions (or “software”). The physical machine 120 may be, as examples, a tablet, a desktop computer, a portable computer, a client, a server, a smartphone, and so forth, depending on the particular implementation. The physical machine 120 may contain virtual components, such as one or multiple virtual machines, one or multiple containers, and so forth. Although depicted in FIG. 1 as being contained in a box, the physical machine 120 may be formed from components (one of multiple blade servers, for example) on a single rack; from components of multiple racks; from components of a data center; from components that are distributed at different geographical locations; and so forth.

In accordance with example implementations, a user may interact with the GUI 123 (via mouse clicks, mouse movements, keyboard entry, touch screen touches and gestures, touch pad touches and gestures, and so forth) to, depending on the user's role, to create software defect reports; edit software defect reports; track status updates for software defect reports; search for historical and/or current software defect reports; add comments to software defect reports; and so forth. Moreover, through the GUI 123, a user may use a developer assignment engine 122 to apply the feedforward neural network classifier 125 to identify, or recommend, one or multiple developers to resolve a defect identified in a given software defect report 110.

Thus, in accordance with example implementations, the developer assignment engine 122 applies the feedforward neural network classifier 125 to the unassigned software defect reports 110 for purposes of producing the reports 150 for which developers have been assigned or at least recommended. Moreover, as further described herein, the feedforward neural network classifier 125 may be trained (by the developer assignment engine 122 or by another component of the computer system 100) based on labeled data, i.e., software defect reports that have been assigned developers to resolve defects associated with the reports.

In accordance with example implementations, the developer assignment engine 122 may be formed by one or multiple physical hardware processors 124 (one or multiple central processing units (CPUs), one or multiple CPU cores, and so forth) of the physical machine 120 executing machine executable instructions 134 (or “software”). The machine executable instructions 134 may be stored in a memory 130 of the physical machine 120. In general, the memory 130 is a non-transitory memory that may be formed from, as examples, semiconductor storage devices, phase change storage devices, magnetic storage devices, memristor-based devices, a combination of storage devices associated with multiple storage technologies, and so forth.

In accordance with example implementations, in addition to the machine executable instructions 134, the memory 130 may store various data 138 (data describing the unassigned software defect reports 110; data representing biases and weights to apply to selected features on which the feedforward neural network classifier 125 is trained; data describing the software defect reports 150 with the recommended developers; data describing feedback to train the feedforward neural network classifier 125 based on training results; and so forth).

In accordance with some implementations, one or more of the components of the developer assignment engine 122 may be implemented in whole or in part by a hardware circuit that does not include a processor executing machine executable instructions. For example, in accordance with some implementations, one or more parts of the developer assignment engine 122 may be formed in whole or in part by a hardware processor that does not execute machine executable instructions, such as, for example, a hardware processor that is formed from an application specific integrated circuit (ASIC), a field programmable gate array (FPGA), and so forth. Thus, many implementations are contemplated, which are within the scope of the appended claims.

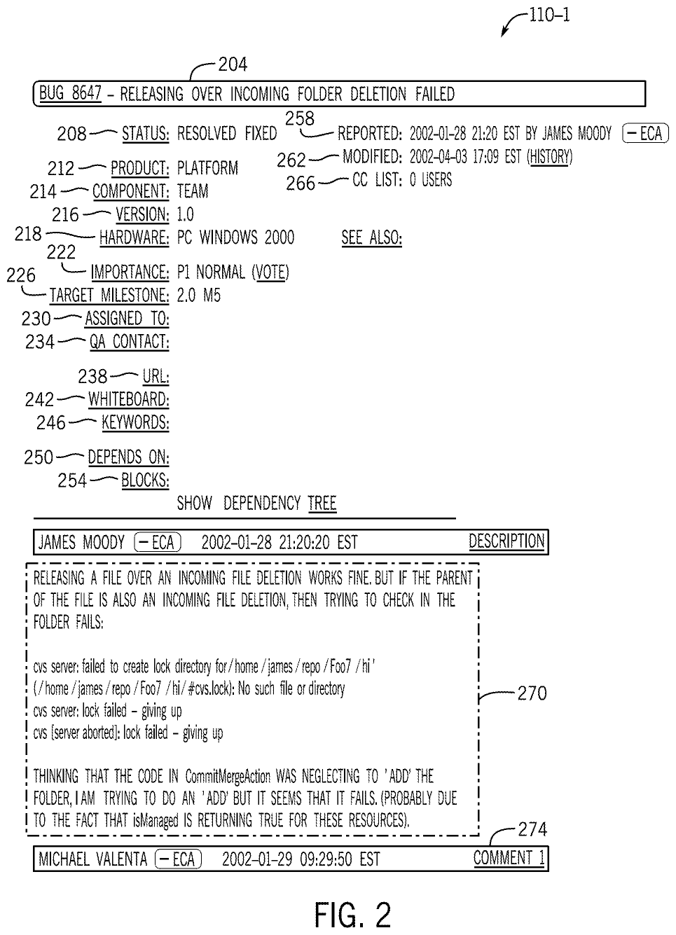

FIG. 2 is an example of a software defect report 110-1, illustrating features that may be extracted from the software defect report 110-1 for purposes of applying machine learning to recommend a developer for a software defect that is identified in the report 110-1. In general, the software defect report 110-1 may include various fields, such as a summary, or title field 204, containing a journalized summary for a reported software defect; a field 208 representing the status (resolved, unresolved, invalid, and so forth) of the software defect; a field 212 describing the software product associated with the software defect; a field 214 representing a type of component associated with the software defect; a field 216 representing a version of the software product; a field 218 identifying hardware associated with the defect; a field 222 denoting a priority, or importance, of the software defect; a field 226 associating the defect with a target milestone; and a field 230 containing the developer (if any) assigned to the software defect report. It is noted that the field 230 may denote an automatically assigned developer used as a default for all software defects or for software defects associated with certain classes (i.e., developers not yet assigned using the machine learning described herein).

As also depicted in FIG. 2, the software defect report 110-1 may indicate various other fields associated with the software defect; such as a quality assurance (QA) contact field 234; a field 238 identifying a uniform resource locator (URL) associated with the software defect; a white board field 242; a field 246 identifying certain keywords associated with the software defect; a field 250 identifying one or multiple dependencies of the software defect; a block field 254; a field 258 listing the developer creating the software defect report 110-1; a field 262 listing a history of modifications made to address the software defects; and a field 266 listing users to copy when changes are made or updated to the software defect report 110-1.

The example software defect report 110-1 may also contain a description field 270, which, in general, contains a description of the problem, such as the environment, input, output, and other descriptions pertaining to the nature and specific circumstances associated with the software defect. Moreover, the example software defect report 110-1 may include a comments field 274, in which various users may post comments pertaining to the software defect, such as attempted fixes to the software defect, progress of the fixes, observations regarding the software defect, and so forth.

In accordance with some implementations, the feedforward neural network classifier 125 may be trained on features extracted specifically from the summary field 204, the description field 270 and the comments field 274; and the neural network classifier 125 may extract features from at least these fields for purposes of applying machine learning to recommend a developer for a given software defect report. In accordance with some implementations, features may be specifically extracted from the summary field 204, the description field 270 and the comments field 274, among other features.

In general, the feedforward neural network classifier 125 may be trained relatively quickly. In addition, the classifier may need relatively less human intervention (as compared to other classifiers) for training purposes, as there is a strong generalization for heterogeneous data sets. In general, the feedforward neural network classifier 125 may having an input layer (with P nodes), a hidden layer (having L nodes), and an output layer (having M output nodes). The output (g(x,wᵢ,bᵢ)) of the ith hidden layer node may be described as follows:

g(x,wᵢ,bᵢ)=g(xwᵢ+bᵢ), Eq. 1

where “wᵢ” represents the input weight between input layer node x and the ith hidden layer node; “bᵢ” represents a bias; and “g” represents an activation function. The sigmoid function may be described as follows:

$$g ( x , {w}_{i} , {b}_{i} ) = \frac{1}{1 + {e}^{- ( x {w}_{i} + {b}_{i} )}} . \qquad Eq . 2$$

The output layer node's number may be represented by “M;” the weight between the ith hidden layer node and the jth output layer node may be represented as “β_{i,j}.” The output of the jth node may be described as follows:

$${f}_{j} ( x ) = {\sum }_{i = 1}^{L} {β}_{i , j} \times g ( x , {w}_{i} , {b}_{i} ) . \qquad Eq . 3$$

Thus, if the input samples are represented by “x” the corresponding output may be represented as follows:

$${f}_{j} ( x ) = {\sum }_{i = 1}^{L} {β}_{i , j} \times g ( x , {w}_{i} , {b}_{i} ) , \qquad Eq . 4$$

of which the output β may be represented as follows:

$$β = [ \begin{matrix}\begin{matrix}{β}_{1} \\ ⋮\end{matrix} \\ {β}_{L}\end{matrix} ] = [ \begin{matrix}{β}_{1 , 1} & … & {β}_{1 , M} \\ ⋮ & ⋮ & ⋮ \\ {β}_{L , 1} & … & {β}_{L , M}\end{matrix} ] \qquad Eq . 5$$

When input a sample, the maximum value of the M output nodes represents the class of the sample.

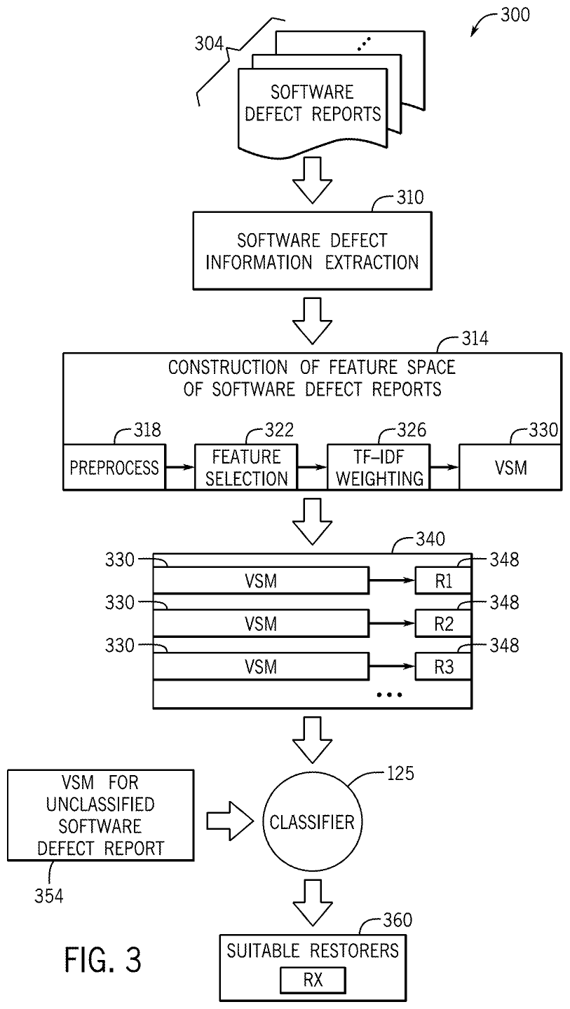

Referring to FIG. 3 in conjunction with FIG. 1, the developer assignment engine 122 may use a process 300 to train and use the feedforward neural network classifier 125. As shown, the process to train the feedforward neural network classifier 125 begins by analyzing historical software defect reports 304, which have been assigned to developers (assigned manually or through a combination of manual and automated assignments, as examples). From the software defect reports 304, the developer assignment engine 122 may extract software defect information, as indicated at reference numeral 310. From the extracted features, a feature space of software defect reports may then be constructed, as indicated at reference numeral 314.

FIG. 3 depicts the construction of the feature space that includes preprocessing 318 the software defect reports to remove irrelevant features; the application of feature selection 322 to remove noise from the extracted features; the application of a text frequency-inverse document frequency (TF-IDF) weighting 326; and a vector space model transformation 330. Accordingly, as depicted at reference numeral 340, the training process has associated feature sets 344 of defects (represented by VSMs) that are labeled with corresponding developers, or restorers 348. Based on the VSMs 344 and the corresponding restorers 348, the developer assignment engine 122 may train the feedforward neural network classifier 125 so that the classifier 125 may classify a software defect report (having an associated VSM 354) with a class affiliated with one or multiple developers, or restorers 360. Moreover, as depicted in FIG. 3, in accordance with some implementations, the feedforward neural network classifier 125 may determine additional information, such as a recommended prescription 361, or a fix, for the software defect.

In accordance with some implementations, the feature extraction begins with extracting selected parts of the software defect report, such as, for example, features associated with the summary, the description and the comments of the report, as well as attribute information for the software defect. In accordance with some implementations, the restorers are extracted as the labels of the training samples. However, the restorers may not always be assigned to the real restorers of software defects. For example, a software defect report may be repaired by another developer, who is not the developer to which the software defect report was first assigned. In this manner, the software defect report may not be timely updated to reflect the actual developer that resolved the software defect.

For purposes of labeling the historical software defect reports with the real restorers of the software defects, the developer assignment engine 122 may apply the following rules. First, in accordance with some implementations, for training purposes, the developer assignment engine 122 may select the software defect reports that have the associated state of “solved,” or “resolved.” Then, if the software defect is repaired by the developer that was assigned to the defect, then the developer assignment engine 122 treats this developer as the final real restorer of the software defect. If, however, the defect is not repaired by a developer, as assigned by the software defect report, then the development in the developer assignment engine 122 assigns the real restorer to the person who last modifies the software defect report to “solved” as being the real restorer.

The parts of the summary, description and comments of the software defect reports use natural language, which may contain a significant amount of irrelevant information. Moreover, the degree of noise (i.e., relevant features) may affect the training of the classifier. Additionally, when the vector space model is used to represent the text document, sometimes, the vector dimensions may reach to thousands to tens of thousands. For purposes of limiting the dimensions of the vector space model and reducing the amount of irrelevant data, the following preprocessing may be used.

First, stemming may be used to replace a given inflected or derived words to their word stems, or root form. For example, the stem of “membership” is “member.” As further examples, the words spending, created, keeps, deletion and normally may be converted to the following stems: spend, creat, keep, delet and normal, respectively. By extracting the stem words, the same or similar word is converted into a consistent form, improves the validity of the selected feature and aids in reducing the dimension of the data. When converting a text document into a vector space model, the same word may have different forms in the description, which is described in natural language on the software defect reports, such as word forms, pass tense, progressive tense, and so forth. In accordance with example implementations, the developer assignment engine 122 may apply one or multiple algorithms based on grammar rules, such as Porter Stemmer and Snowball Stemmer.

In accordance with some implementations, the developer assignment engine 122 further removes stop words. In general, stop words are functions words in the human language, which are extremely common. Compared with other words, these words have no actual meaning, such as “the,” “is,” “a,” “at,” “which,” “that,” “on,” and numbers, characters, punctuation, etc. Although these stop words cannot separately express the degree of correlation about documents, these stop words will take up a lot of space. In general, for purposes of establishing the vector space model, the stop words are removed to reduce the vector dimension and at the same time, not affect the precision.

In accordance with example implementations, after reducing the extracted features to the stem words and removing the stop words, the developer assignment engine 122 performs feature selection. In general, feature selection removes terms that are either redundant or irrelevant. In general, the feature selection removes noise in the data, decreases the complexity of time and complexity of space of the classification and increases the accuracy of the classification. In accordance with example implementations, the developer assignment engine 122 uses a feature selection method to reduce the dimension of the feature space and noise. Depending on the particular implementation, the developer assignment engine 122 may apply a number of feature selection algorithms, such as Information Gain (IG), Chi-square (CHI), MutualInformation-on (MI), Term Strength (TS), etc. As a specific example, the developer assignment engine 122 may use IG as the feature selection algorithm, in accordance with some implementations. The IG feature selection formula used by the algorithm may be described as follows:

$$I G ( w ) = P ( w ) {\sum }_{t} P ( {C}_{t} / w ) log \frac{P ( {C}_{t} / w )}{P ( {C}_{t} )} + P ( \overline{w} ) {\sum }_{t} P ( {C}_{t} l \overline{w} ) log \frac{P ( {C}_{t} / \overline{w} )}{P ( {C}_{t} )} , \qquad Eq . 6$$

where “l” represents the number of development tags; “P(w)” represents the probability of feature w; P(Cₜ/w) represents the conditional probability of belonging to developer Cₜ class when the text contains feature w; “P(Cₜ)” represents the probability of information text belonging to the developer Cₜ in a text set; P(w̅) represents the probability of which feature w doesn't appear in the text; and P(Cₜ/w̅) represents the probability of belonging to developer Cₜ class when the text does not contain feature w.

Thus, the feature selection produces a subset of extracted features, which are used to form the vector space model, as further described below. The vector space model, in addition to considering which features are present and not present in a particular software defect report, also assigns weights to the present features. These weights are determined by the developer assignment engine 122, in accordance with some implementations, using text frequency-inverse document frequency (TF-IDF) weighting. If a word shows up in a paper in high frequency, and rarely appears in other papers, this word has a very good ability of differentiating category and is suitable to classification.

For a given feature word tᵢ, the tf_{i,j} of this word may be expressed as followed:

$${tf}_{i , j} = \frac{{n}_{i , j}}{{\sum }_{k} {n}_{k , j}} \qquad Eq . 7$$

In Eq. 7, “n_{i,j}” represents the number of the feature word appearing in the document dⱼ. The denominator represents the sum of all words that occur in the file. idfᵢ of this word shown as:

$${idf}_{i} = log ( 1 + \frac{\vert D \vert}{1 + \vert \{ j \{ {t}_{i} ∈ {d}_{j} \} \vert} ) \qquad Eq . 8$$

|D| is the total number of files in the file set. |{j:tᵢ∈dⱼ}| represents the files number including feature word tᵢ. If this feature word is not in the file set, then the denominator is zero, so it is written in 1+|{j:tᵢ∈dⱼ}|. The weight w_{i,j} of feature word tᵢ in files dⱼ can be expressed as:

$${w}_{i , j} = \frac{{tf}_{i , j}}{{max}_{j} ( {tf}_{k , j} \}} \times {idf}_{i} , \qquad Eq . 9$$

maxⱼ{tf_{k,j}} is the maximum of feature words tf in files dⱼ. The weights of all the feature words with the above methods are calculated, and the process is normalized to establish vector space model VSM.

The vector space model has a dimension that corresponds to the number of selected features. In this manner, each dimension of the vector space model has an associated dimension value, which indicates whether the corresponding selected feature is present or not in the software defect report. For example, in accordance with some implementations, if the corresponding feature is not present in the software defect report, then the corresponding dimension value is “0.” Otherwise, the corresponding dimension value is nonzero. Moreover, in lieu of merely denoting a dimension value in a binary fashion as “1” (present) or “0” (absent), the VSM is weighted using the TF-IDF weightings discussed above. In this manner, if the VSM dimension value is “0,” then the corresponding weighted value is also “0.” However, if the corresponding feature is present, then, in accordance with example implementations, the VSM dimension value is the weight assigned to the feature.

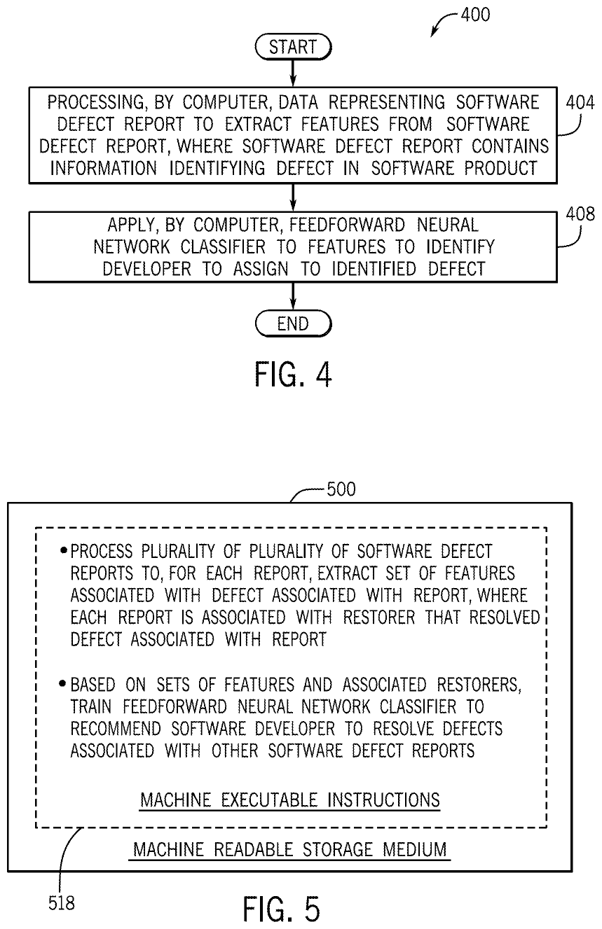

Referring to FIG. 4, in accordance with example implementations, a technique 400 includes processing (block 404), by a computer data representing a software defect report to extract features from the software defect report. The software defect report contains information that identifies a defect in a software product. The technique 400 includes applying (block 408), by the computer, a feedforward neural network classifier to the features to identify a developer to assign to the identified defect.

Referring to FIG. 5, in accordance with example implementations, a non-transitory machine readable storage medium 500 stores machine readable instructions 518 to, when executed by a machine, cause the machine to process a plurality of software defect reports to, for each report, extract a set of features that are associated with a defect associated with the report. Each report is associated with a restorer that resolved the defect that is associated with the report. The instructions 518, when executed by the machine, cause the machine to, based on the sets of features and the associated restorers, train a feedforward neural network classifier to recommend software developers to resolve defects that are associated with other software defect reports.

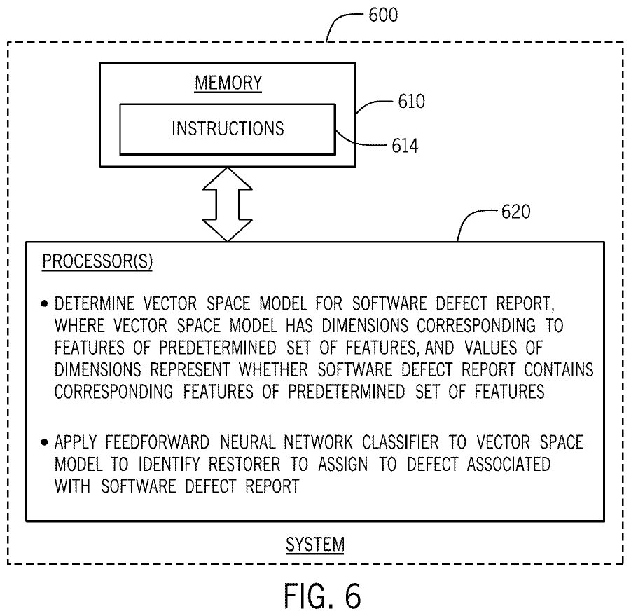

Referring to FIG. 6, in accordance with example implementations, an apparatus 600 includes at least one processor 620 and a memory 610. The memory 610 stores instructions 614 that, when executed by the processor(s) 620, cause the processor(s) 620 to determine a vector space model for a software defect report. The vector space model has dimensions corresponding to features of a predetermined set of features, and the values of the dimensions represent whether the software defect report contains the corresponding features of the predetermined set of features. The instructions 614, when executed by the processor(s) 620, cause the processor(s) 620 to apply a feedforward neural network classifier to the vector space model to identify a restorer to assign to a defect that is associated with the software defect report.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
processing, by a computer, data representing a software defect report to extract features from the software defect report, wherein the software defect report contains information identifying a defect in a software product; and
applying, by the computer, a feedforward neural network classifier to the features to identify a developer to assign to the identified defect.

2. The method of claim 1, wherein:
the software defect report contains a first field containing a description of the defect, and a second field other than the first field containing a summary of the defect;
processing the data comprises extracting a feature from first field and extracting a feature from the second field; and
applying the feedforward neural network classifier comprises applying the classifier to the features extracted from the first and second fields.

3. The method of claim 1, wherein:
the software defect report further contains a field containing comments related to fixing the defect;
processing the data comprises extracting a feature from the field; and
applying the feedforward neural network classifier further comprises applying the classifier to the feature extracted from the field.

4. The method of claim 1, wherein applying the feedforward neural network classifier comprises applying a classifier that has a single hidden layer.

5. The method of claim 1, wherein applying the feedforward neural network classifier comprises applying the feedforward neural network classifier to identify a class associated with a plurality of developers.

6. The method of claim 1, wherein processing the software defect report to extract features comprises applying stemming to determine root words of words contained in the software defect report.

7. The method of claim 1, wherein applying the feedforward neural network classifier comprises determining a tuple having a plurality of dimensions corresponding to the extracted features and applying the feedforward neural network classifier to the tuple to identify the developer to assign to the identified defect.

8. The method of claim 7, further comprising:
assigning zeroes for dimension values of the tuple in response to the features not corresponding to dimensions of the tuple.

9. The method of claim 7, wherein determining the tuple comprises assigning weights to dimension values of the tuple corresponding to the features.

10. A non-transitory machine readable storage medium that stores machine readable instructions to, when executed by a machine, cause the machine to:
process a plurality of software defect reports to, for each report of the plurality of reports, extract a set of features associated with a defect associated with the report, wherein each report of the plurality of reports is associated with a restorer that resolved the defect associated with the report; and
based on the sets of features and the associated restorers, train a feedforward neural network classifier to recommend software developers to resolve defects associated with other software defect reports.

11. The storage medium of claim 10, wherein the instructions, when executed by the machine, further cause the machine to:
for a given software report of the plurality of software reports, identify the restorer associated with the given software report, wherein identifying the restorer comprises determining, based on the given software report, whether a restorer designated by the given software report resolved the defect associated with the given report.

12. The storage medium of claim 11, wherein the instructions, when executed by the machine, further cause the machine to, in response to determining that the restorer designated by the given software report did not resolve the defect associated with the given report, identify another restorer to be associated with resolving the defect associated with the given report.

13. The storage medium of claim 11, wherein the instructions, when executed by the machine, further cause the machine to generate a vector space model based on the extracted features and train the feedforward neural network classifier based on the vector space model.

14. The storage medium of claim 11, wherein the instructions, when executed by the machine, further cause the machine to, for a given software report of the plurality of software reports, process words contained in the given software report to consolidate the words into their corresponding roots.

15. An apparatus comprising:
at least one processor; and
a memory to store instructions that, when executed by the at least one processor, cause the at least one processor to:
determine a vector space model for a software defect report, wherein the vector space model has dimensions corresponding to features of a predetermined set of features, and values of the dimensions represent whether the software defect report contains the corresponding features of the predetermined set of features; and
apply a feedforward neural network classifier to the vector space model to identify a restorer to assign to a defect associated with the software defect report.

16. The apparatus of claim 15, wherein the instructions, when executed by the at least one processor, further cause the at least one processor to determine the vector space model based on words contained in a title of the software defect report.

17. The apparatus of claim 15, wherein the instructions, when executed by the at least one processor, further cause the at least one processor to determine the vector space model based on words contained in a comments field of the software defect report.

18. The apparatus of claim 15, wherein the instructions, when executed by the at least one processor, further cause the at least one processor to applying the feedforward neural network classifier to identify a class associated with a plurality of restorers.

19. The apparatus of claim 15, wherein the instructions, when executed by the at least one processor, further cause the at least one processor to apply stemming to determine root words of words contained in the software defect report and apply the feedforward neural network classifier based on the root words to identify the restorer.

20. The apparatus of claim 15, wherein:
the vector space model comprises a tuple having a plurality of dimension values corresponding to the dimensions of the vector space model;
a given dimension value of the plurality of dimension values of the tuple corresponds to a given feature of the predetermined features;
the given dimension value has a zero value to represent that the software report does not contain the given feature; and
the given dimension value has a nonzero value to represent that the software defect report contains the given feature.
